(19) United States
(12) Patent Application Publication
(10) Pub. No.: US 2008/0217985 A1
(43) Pub. Date: Sep. 11, 2008

(54) Load Transport Bin

(76) Inventor: Leslie James Botha, Ermelo (ZA)

Correspondence Address: KNOBBE MARTENS OLSON & BEAR LLP, 2040 MAIN STREET, FOURTEENTH FLOOR, IRVINE, CA, 92614, US

(21) Appl. No.: 11/997,121

(22) PCT Filed: Jul. 17, 2006
(86) PCT No.: PCT/ZA2006/000088

§ 371 Date: Jan. 28, 2008

(30) Foreign Application Priority Data
Jul. 26, 2005 (ZA) 2005/5973

(51) Int. Cl. B60P 1/34; B60P 1/28

(52) U.S. Cl. 298/11; 298/17 R

(57) ABSTRACT

The invention provides a bin for transporting and off-loading a load such as ore and coal. The bin includes two parts, a load bearing floor part of which at least a portion slopes downward to a side of the floor and an enclosure part having a wall, this part being configured so that the lower end of the wall is complementary to the floor, with the two parts together, in use, defining a bin.

### TECHNICAL FIELD OF THE INVENTION

This invention relates to a bin for transporting and off-loading a load.

### BACKGROUND TO THE INVENTION

The applicant is aware that loads such as coal, ore, grain, earth are transported on trucks while contained in a bin. The load is normally off-loaded by tilting the bin in combination with a hinged side wall which opens to allow the load to flow out of the bin.

Known load transport bins are tilted by means of hydraulic or pneumatic piston and cylinder arrangements. In order to tilt the bin, at least part of the weigh of the bin and load inside the bin need to be lifted and a large force is needed to tilt the bin, especially when the bin carries a heavy load. The tilting arrangement and hinges of the hinged side wall includes many moving parts and requires high maintenance.

It is an object of this invention to provide a bin for transporting and safely off-loading a load while requiring relatively low maintenance and relatively low forces to unload the bin.

A bin will be understood to mean a container for use on, or fixed to, vehicles or trailers for the transport of loads. The container may be open topped.

### GENERAL DESCRIPTION OF THE INVENTION

According to a first aspect of the invention there is provided a bin for transporting and off-loading a load, which bin includes:

a load bearing floor part of which at least a portion slopes downward to a side of the floor; and

an enclosure part having a wall, this part being configured so that the lower end of the wall is complementary to the floor, with the two parts together, in use, defining a bin.

The lower end of the wall may be complementary profiled to the floor to seal sufficiently with the floor, in use, to carry at least solid materials such as particulate ore and coal.

The lower end of the wall is complementary to the floor and may rest flush on the floor, in use, to define a bin.

The enclosure part may have two pairs of generally opposed walls. The bin may be generally oblong shaped in plan view.

The load bearing floor may be shaped to define a ridge parallel to a pair of opposed walls from which ridge two opposed portions of the floor slope downward to its respective wall. The bin may be oblong shaped and the ridge may be along the length of the bin.

The bin may be provided with mechanical advantage means for lifting the enclosure part, or part thereof, upward away from the floor. It will be appreciated that when the enclosure part is lifted, a load capable of flowing will flow down the sloping floor to spill over an edge of the floor, thereby off loading the load.

The enclosure part may be lifted generally straight upward to unload both sides or on one side to unload on one side.

The bin may also include a guide for guiding the enclosure part relative to the floor part. The guide may include two guide parts, a rod and complementary sleeve. One part may be fixed to the floor part and the other to the enclosure part.

The guide may be configured to allow both and/or the one side only of the enclosure part to be lifted. The guide part fixed to the floor part may include a pivot point to allow the one side only of the enclosure part to be lifted.

The mechanical advantage means may include a pneumatic or hydraulic cylinder and rod arrangement. The mechanical advantage means may include two pairs of cylinder and rod arrangements, each pair being positioned at an opposed wall proximate the outside of the bin. It will be appreciated that one end of the cylinder and rod arrangement is attached to the floor and the other end attached to the enclosure part to enable the enclosure part to be lifted from the floor to open the bin.

Alternatively, preferably, the mechanical advantage means may be an air spring system. The air spring system may be in pneumatic communication with the pneumatic system of a vehicle, typically the air brake and/or air suspension system of a truck.

The bin may be used on any load carrying vehicle, such as trucks and trailers for trucks, rolling or railway stock or the like.

The invention also extends to a vehicle fitted with a bin for transporting and off-loading a load.

The invention also extends to a method off loading a load, which method includes the step of lifting an enclosure part, as described above, from a load carrying floor, as described above, to allow the load to spill over an edge of the floor thereby unloading, in use, the load.

### DETAILED DESCRIPTION OF THE INVENTION

The invention is now described by way of example with reference to the accompanying drawings.

In the Drawings:

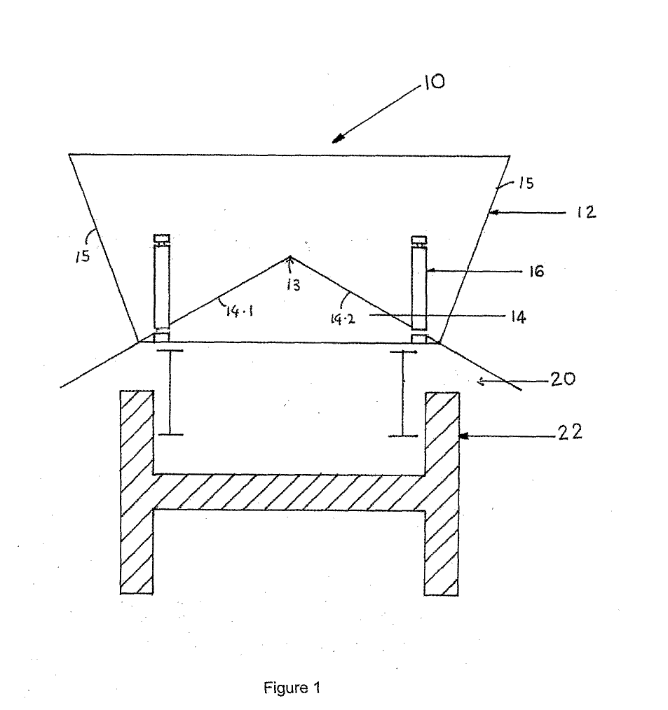

FIG. 1 shows diagrammatically an end view of a vehicle fitted with a bin for transporting and off-loading a load, in a closed state, in accordance with the invention;

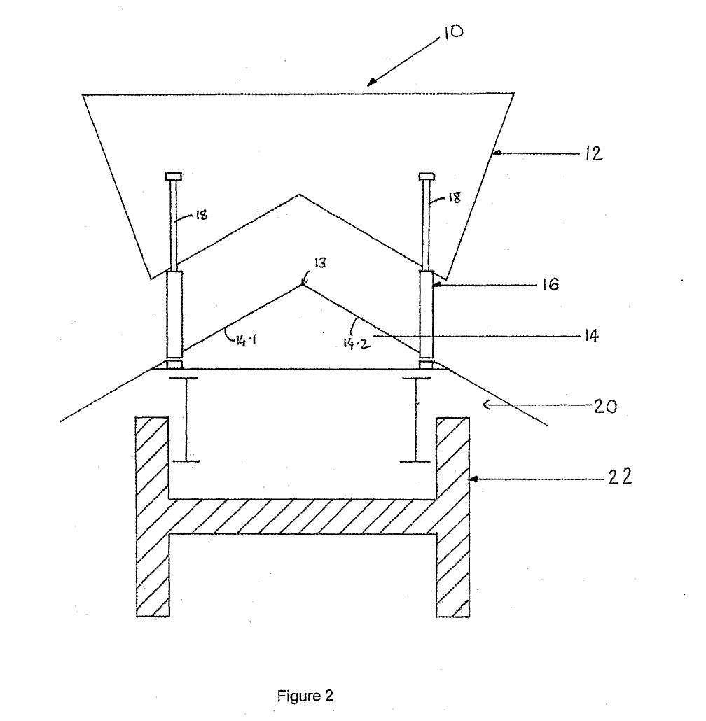

FIG. 2 shows diagrammatically an end view of a vehicle fitted with a bin for transporting and off-loading a load, in an open state;

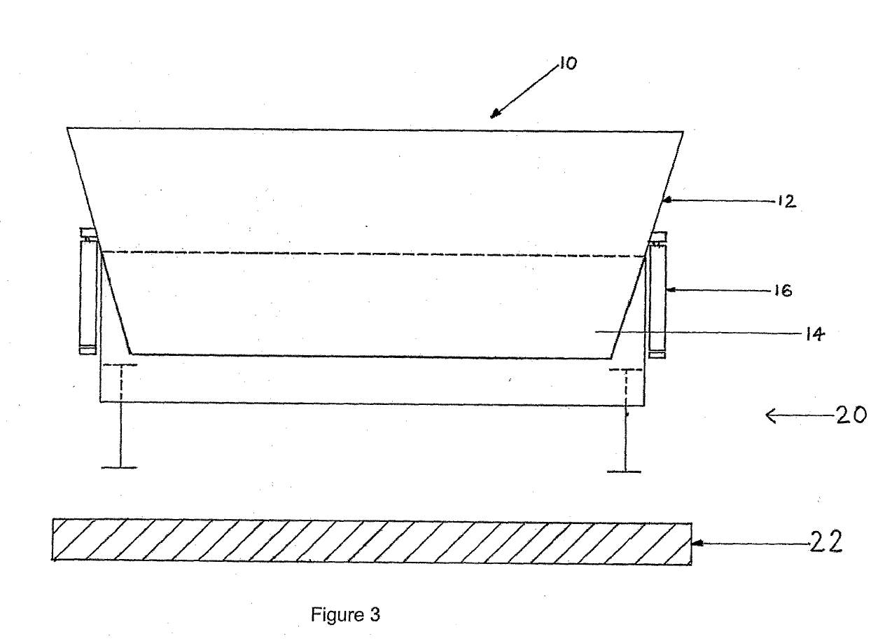

FIG. 3 shows diagrammatically a side view of a vehicle fitted with a bin for transporting and off-loading a load, in a closed state;

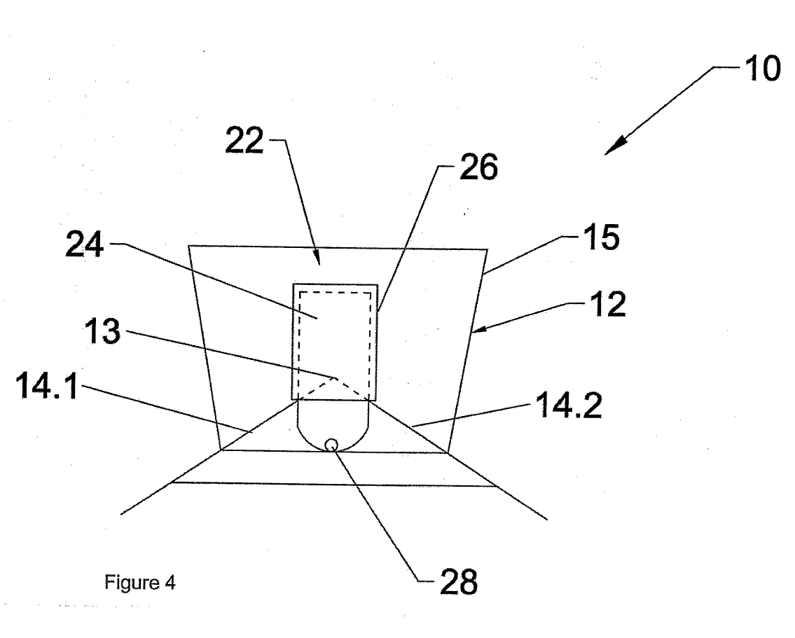

FIG. 4 shows diagrammatically an end view of a further embodiment of a bin for transporting and off-loading a load, in a closed state, in accordance with the invention; and

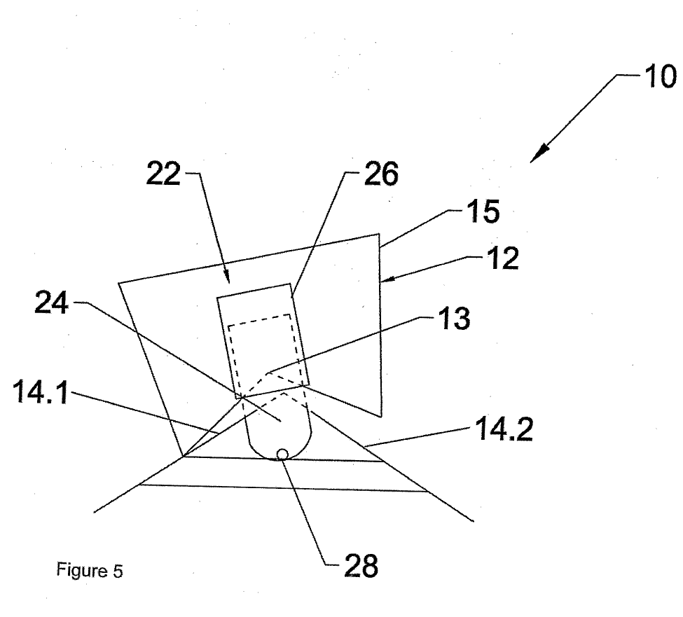

FIG. 5 shows diagrammatically an end view of the bin for transporting and off-loading a load, in an open state.

Referring now to the drawings, the bin for transporting and off-loading a load, in accordance with the invention, is generally indicated by reference numeral 10.

The bin 10 fitted to a trailer 20 is oblong shaped and includes a load bearing floor 14 of plate steel. The floor 14 is shaped to define a ridge 13 parallel to a pair of opposed walls 15 of an enclosure part 12. Two opposed floor portions 14.1 and 14.2 slope downward from the ridge 13 to its respective wall 15. The lower ends of the walls 15 and 17 of the enclosure part 12 are configured so that the lower end of the walls 15 and 17 are complementary to the floor 14 to rest flush on the floor 14, in use, to define a bin 10.

The bin 10 includes mechanical advantage means in the form of two pairs of pneumatic cylinder 16 and rod 18 arrangements. Each pair is positioned at an opposed wall 17 at the outside of the bin 10. The end of the cylinder 16 is attached to the floor 14 and the rod 18 is attached to the enclosure part 12 to enable the enclosure part 12 to be lifted from the floor 14 to open the bin 10 (FIG. 2). It will be appreciated that minimal force is required to lift the bin enclosure part 12 since little or no part of the load need to be lifted. Also, the cylinder 16 and rod 18 arrangements, which are configured only to lift the enclosure part 12, need minimal moving parts since it does not need to articulate.

Referring now to FIGS. 4 and 5. These figures demonstrate an embodiment which allows, in addition to lifting the enclosure part 12 straight up, lifting one side of the enclosure part 12. This embodiment of the bin 10 includes a guide 22 for guiding the enclosure part 12 relative to the floor part 14. The guide 22 includes two parts, a rod 24 and complementary sleeve 26. The rod 24 is pivotally fixed to the floor part 14 and the sleeve 26 is fixed to the enclosure part 12.

The guide 20 is configured to allow the one side only of the enclosure part 12 to be lifted as well as lifting the enclosure part straight up, with both sides of the enclosure part 12 rising. The rod 24 is pivotably fixed to the floor part 14 and includes a pivot point 28 to allow the one side only of the enclosure part 14 to be lifted.

In use, a person operating a vehicle fitted with a bin 10, as described above, unloads a load onto load areas alongside the vehicle by activating the mechanical advantage means. The applicant believes that the invention provides a time saving way of unloading a load and low maintenance load carrying and offloading bins. The applicant further believes that the ridge 13 of the floor 14 balances the weight of the load and evenly distributes the weight during off loading to opposite sides of the vehicle, thereby minimizing the chance of the vehicle tipping over. The load can also be off loaded while driving to save time and spread the load over an area. There is also no need to remove a covering sheet, thereby saving more time.

It shall be understood that the example is provided for illustrating the invention further and to assist a person skilled in the art with understanding the invention and is not meant to be construed as unduly limiting the reasonable scope of the invention.

1. A bin for transporting and off-loading a load, which bin comprises:
a load bearing floor part of which at least a portion slopes downward to a side of a floor when the bin is mounted on a vehicle, in use, the vehicle being in a horizontal position; and
an enclosure part having a wall, the enclosure part being configured so that a lower end of the wall is complementary to the floor, with the load bearing floor part and the enclosure part together, in use, defining a bin, and wherein the enclosure part, or part thereof, is liftable upward away from the floor part.

2. The bin as claimed in claim 1, wherein the lower end of the wall is complementary profiled to the floor to define a bin.

3. The bin as claimed in claim 2, wherein the lower end of the wall rests flush on the floor, in use, to define a bin.

4. The bin as claimed in claim 1, wherein the enclosure part comprises two pairs of generally opposed walls and the load bearing floor is shaped to define a ridge parallel to a pair of opposed walls from which ridge two opposed portions of the floor slope downward to its respective enclosure part wall.

5. The bin as claimed in claim 1, wherein the bin comprises a mechanical advantage means for lifting the enclosure part, or part thereof, upward away from the floor.

6. The bin as claimed in claim 5, wherein the mechanical advantage means is configured to lift the enclosure part generally straight upward.

7. The bin as claimed in claim 5, wherein the mechanical advantage means is configured to lift the enclosure part on one side to unload on one side.

8. The bin as claimed in claim 5, wherein the mechanical advantage means is configured to lift the enclosure part generally straight upward to unload the load on two sides and to lift the enclosure part on one side to unload on one side, as desired by an operator, in use.

9. The bin as claimed in claim 7, which bin comprises a guide for guiding the enclosure part relative to the floor part.

10. The bin as claimed in claim 9, wherein the guide comprises two guide parts, a rod and complementary sleeve, with one guide part fixed to the floor part and the other guide part to the enclosure part.

11. The bin as claimed in claim 10, wherein the guide part which is fixed to the floor part comprises a pivot point configured to allow one side only of the enclosure part to be lifted.

12. The bin as claimed in claim 5, wherein the mechanical advantage means comprises a pneumatic or hydraulic cylinder and rod arrangement.

13. The bin as claimed in claim 12, wherein the mechanical advantage means comprises two pairs of cylinder and rod arrangements, each pair being positioned proximate an opposed wall of the enclosure part at the outside of the bin.

14. The bin as claimed in claim 12, wherein the mechanical advantage means is an air spring system.

15. A vehicle which comprises a bin as claimed in claim 1.

16-17. (canceled)

18. The bin as claimed in claim 8, which bin comprises a guide for guiding the enclosure part relative to the floor part.
